(19) United States
(12) Patent Application Publication
(10) Pub. No.: US 2015/0244764 A1
(43) Pub. Date: Aug. 27, 2015

(54) METHOD AND DEVICE FOR ACCESSING A WEBSITE

(71) Applicant: Xiaomi Inc., Beijing (CN)

(72) Inventors: Tiejun Liu, Beijing (CN); Zheng Li, Beijing (CN); Liang Cheng, Beijing (CN)

(21) Appl. No.: 14/522,840

(22) Filed: Oct. 24, 2014

Related U.S. Application Data
(63) Continuation of application No. PCT/CN2014/082937, filed on Jul. 24, 2014.

(30) Foreign Application Priority Data
Feb. 27, 2014 (CN) 201410069570.6

(51) Int. Cl. H04L 29/08; H04L 29/06

(52) U.S. Cl. CPC H04L 67/02; H04L 67/42

(57) ABSTRACT

A method for use in a router, includes: obtaining a destination web address and destination post content; generating a post request in accordance with the destination post content; sending the post request to the destination web address; receiving a return message returned from the destination web address in accordance with the post request; judging whether the received return message is a predetermined return message; and if the received return message is not the predetermined return message, continuing to send the post request to the destination web address until the received return message is the predetermined return message.

### CROSS REFERENCE TO RELATED APPLICATIONS

This application is a continuation of International Application No. PCT/CN2014/082937, filed Jul. 24, 2014, which is based upon and claims priority to Chinese Patent Application No. 201410069570.6, filed Feb. 27, 2014, the entire contents of all of which are incorporated herein by reference.

### TECHNICAL FIELD

The present disclosure generally relates to the field of network equipment technology and, more particularly, to a method and a device for accessing a website.

### BACKGROUND

Conventionally, information resources are available on the Internet, known as an information resource network. For instance, hospital registration can be implemented on the Internet, reservations for museums and other showplaces can be made on the Internet, and hotel, train and airline tickets can be booked on the Internet. When a user wants to obtain information resources, the user can use a browser on a computer, a mobile phone, or a smart terminal to access a website providing the information resources, and perform operations, such as filling in forms and registration, to request the information resources. If this resource request is unsuccessful, the user may need to perform the operations again many times, to resend the request, which lengthens the time for obtaining the information resources and makes the user's operations inconvenient.

### SUMMARY

According to a first aspect of the present disclosure, there is provided a method for use in a router, comprising: obtaining a destination web address and destination post content; generating a post request in accordance with the destination post content; sending the post request to the destination web address; receiving a return message returned from the destination web address in accordance with the post request; judging whether the received return message is a predetermined return message; and if the received return message is not the predetermined return message, continuing to send the post request to the destination web address until the received return message is the predetermined return message.

According to a second aspect of the present disclosure, there is provided a router, comprising: a processor; a memory for storing instructions executable by the processor; wherein the processor is configured to: obtain a destination web address and destination post content; generate a post request in accordance with the destination post content; send the post request to the destination web address; receive a return message returned from the destination web address in accordance with the post request; judge whether the received return message is a predetermined return message; and if the received return message is not the predetermined return message, continue to send the post request to the destination web address until the received return message is the predetermined return message.

According to a third aspect of the present disclosure, there is provided a non-transitory computer-readable storage medium storing therein instructions that, when executed by a processor of a router, cause the router to perform a method for accessing a website, the method comprising: obtaining a destination web address and destination post content; generating a post request in accordance with the destination post content; sending the post request to the destination web address; receiving a return message returned from the destination web address in accordance with the post request; judging whether the received return message is a predetermined return message; and if the received return message is not the predetermined return message, continuing to send the post request to the destination web address until the received return message is the predetermined return message.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for accessing a website, according to an exemplary embodiment.

FIG. 2 is a flow chart of a method for accessing a website, according to an exemplary embodiment.

FIG. 3 is a flowchart of a method for accessing a website, according to an exemplary embodiment.

FIG. 4 is a flowchart of a method for accessing a website, according to an exemplary embodiment.

FIG. 5 is a flowchart of a method for accessing a website, according to an exemplary embodiment.

FIG. 6 is a flowchart of a method for accessing a website, according to an exemplary embodiment.

FIG. 7 is a flowchart of a method for accessing a website, according to an exemplary embodiment.

FIG. 8 is a block diagram of a device for accessing a website, according to an exemplary embodiment.

FIG. 9 is a block diagram of a device for accessing a website, according to an exemplary embodiment.

FIG. 10 is a block diagram of a device for accessing a website, according to an exemplary embodiment.

FIG. 11 is a block diagram of a router, according to an exemplary embodiment.

FIG. 12 is a block diagram of a server, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

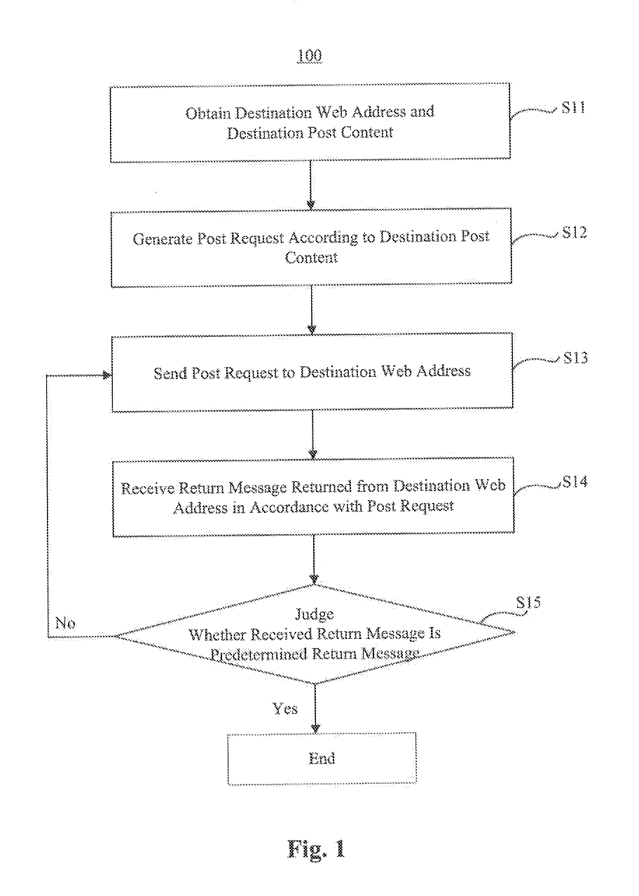

FIG. 1 is a flowchart of a method 100 for accessing a website, according to an exemplary embodiment. In the exemplary embodiment, the method 100 is used in a router. Referring to FIG. 1, the method 100 includes the following steps.

In step S11, the router obtains a destination web address and destination post content.

The destination web address refers to a web address of a website to which a user needs to send a post request. In the present disclosure, a post is a request method supported by the HTTP protocol used by the World Wide Web. The post request method is used to request that a web server accept data enclosed in a message's body. The destination web address can be a web address of a shopping website, such as a web address of Taobao, a web address of Jingdong, or a web address of Yihaodian. The destination web address can also be a web address for booking tickets or a web address for making a reservation for services, such as a ticket booking web address, an airline ticket booking web address, a hotel booking web address, or a travelling booking web address.

The destination post content refers to information to be submitted to the destination web address through the post request by the user. In exemplary embodiments of the present disclosure, the destination post content can be set at discretion according to the destination web address. For instance, for the shopping web address, the destination post content can be a name, an amount, a payment method, a delivery selection, and a delivery address of purchased good, etc. Also for example, for booking train tickets and airline tickets, the destination post content can be a departure, a destination, a train or flight number, a departure date, a seat selection, a number of booking tickets, identity information about the passengers, etc. Further for example, for booking hotels or travel tickets, the destination post content is similar to that listed above, as long as the destination post content includes information required by the corresponding service.

In one exemplary embodiment, the user inputs the destination web address and the destination post content on the router directly. In another embodiment, the destination web address and the destination post content are submitted to the router by using a terminal, such as a mobile phone, a tablet, or a computer.

In step S12, the router generates a post request according to the destination post content.

In exemplary embodiments, by using a format of a post request in a network transport protocol, the router generates the post request according to the destination post content. The generated post request includes information corresponding to the destination post content.

In step S13, the router sends the post request to the destination web address.

For example, the router sends the generated post request to a server corresponding to the destination web address through a network.

In step S14, the router receives a return message returned from the destination web address in accordance with the post request.

For example, after the server corresponding to the destination web address receives the post request, the server returns the return message according to the post request to notify the user of a result of the post request sent to the destination web address. The return message can include predetermined characters, such as success or failure of booking tickets, and can also include information related to the destination post content, such as a departure, a destination, a train or flight number, a departure date, a seat selection, a number of booking tickets, and identity information about passengers.

In exemplary embodiments, return messages of different types, formats and/or contents from the same destination address can represent different results, whereas return messages of different types, formats and/or contents from different destination addresses are usually used to represent different results. Moreover, destination web addresses of similar websites can use return messages of the same type, format and/or content. For example, the website of Taobao and the website of Tmall are similar websites since Taobao and Tmall belong to the same parent company. Also for example, websites for booking hotels can also be considered similar websites.

In step S15, the router judges whether the received return message is a predetermined return message. For example, if the router determines that the received return message has a predetermined feature, the router judges that the received return message is a predetermined return message.

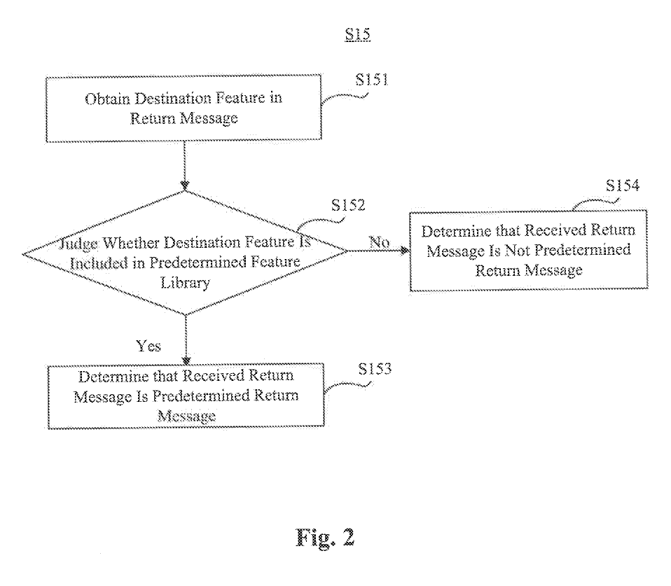

FIG. 2 is a flowchart of substeps of step S15, according to an exemplary embodiment. Referring to FIG. 2, step S15 may include the following substeps.

In substep S151, the router obtains a destination feature in the received return message.

In exemplary embodiments, the destination feature can uniquely recognize or confirm a feature of the return message. For example, the destination feature can be a predetermined character, a predetermined number, a character and/or a number in at least one field corresponding to the destination post content in the return message. In addition, the destination feature can also be a format of the return message, etc.

In substep S152, the router judges whether the destination feature is included a predetermined feature library.

In exemplary embodiments, predetermined feature libraries respectively corresponding to different destination web addresses can be established in advance. After receiving the return message, the router can compare the destination feature with features in the predetermined feature library by using, e.g., a look-up table scheme, etc.

When the predetermined feature library includes the destination feature, in step S153, it is determined that the received return message is the predetermined return message. When the predetermined feature library excludes the destination feature, in step S154, it is determined that the received return message is not the predetermined return message.

Referring back to FIG. l, when the received return message is not the predetermined return message, the process returns back to step S13 and the router continues to send the post request to the destination web address until, e.g., the received return message is the predetermined return message.

In the method 100, during the process of obtaining a resource on the Internet, referred to hereafter as the network resource, the router only needs to obtain the destination web address and the destination post content once (generally the first time in the process of obtaining the network resource), and determines whether the return message received in the network resource obtaining process is the predetermined return message. When the predetermined return message is not received, the post request can be automatically sent for additional times until the return message of this network resource obtaining process is the predetermined return message.

The method 100 can overcome the problem that the user needs to input the post request repeatedly if the first request fails, as in the related art, and the user's operation is easy and convenient.

In addition, in the method 100, the user only needs to send the destination web address and the destination post content once to the router, e.g., through the terminal, and remaining interactions among data are totally implemented between the router and the server corresponding to the destination web address. In comparison with the related art, the method 100 needs not present the return message of the post request to the user and send the post request again by the user after operations every time, which reduces the number of interactions between the router and the terminal, and further decreases the time consumed for the process of obtaining the network resource. Also, the time interval of two adjacent post requests sent by the router is reduced, the number of sendings of the post requests through the router per unit time is increased, and a success rate of obtaining the network resource is improved.

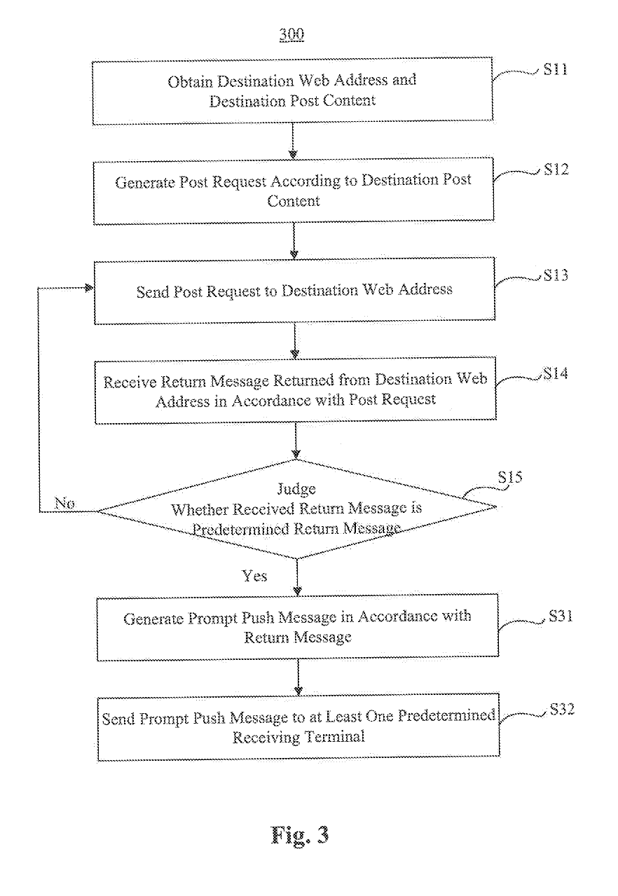

FIG. 3 is a flowchart of a method 300 for accessing a website, according to an exemplary embodiment. Referring to FIG. 3, in addition to steps S11-S15 (FIG. 1), the method 300 further includes the following steps.

When the received return message is the predetermined return message, in step S31, the router generates a prompt push message in accordance with the return message. The generated prompt push message includes information corresponding to the return message.

In step S32, the router sends the prompt push message to at least one predetermined receiving terminal, to inform the user of the result of the post request. Also, sending the prompt push message enables the user to know the result of the post request quickly.

In exemplary embodiments, the prompt push message is sent in a format including one of a text message, an email, a webpage message, an Internet push message, and a local area network (LAN) notification message, or a combination thereof. The at least one predetermined receiving terminal can be a mobile terminal, a computer, or any other network terminal.

Through sending the prompt push message, the result of the post request can be quickly informed to the user in time in a manner preset by the user, which facilitates the user's checking the return message, and implements a subsequent operation according to the return message, such as payment, cancellation of an order, or revision of information in the order.

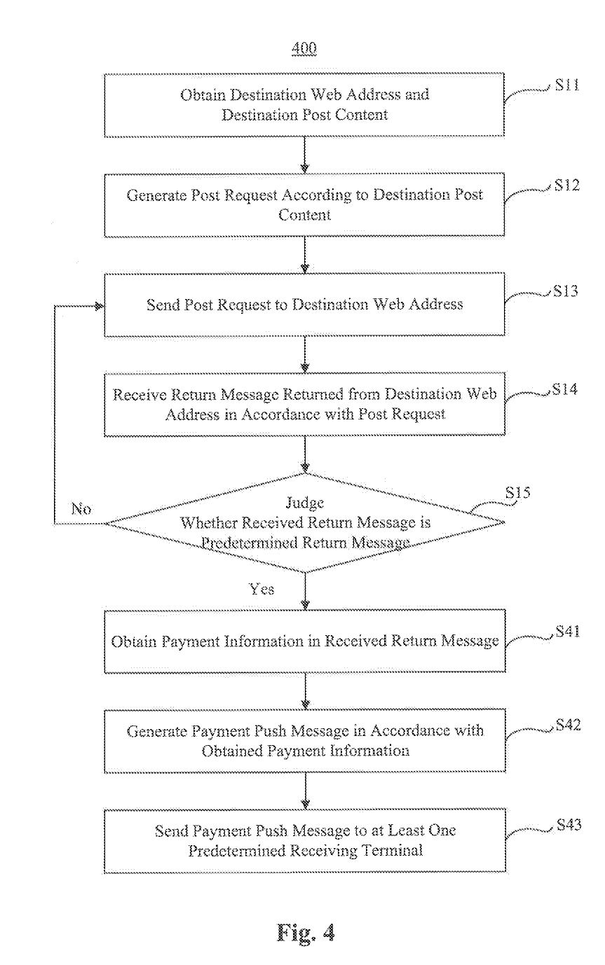

FIG. 4 is a flowchart of a method 400 for accessing a website, according to an exemplary embodiment. Referring to FIG. 4, in addition to steps S11-S15 (FIG. 1), the method 400 further includes the following steps.

When the received return message is the predetermined return message, in step S41, the router obtains payment information in the received return message.

In the illustrated exemplary embodiment, to facilitate the operation of the user, when the received return message is the predetermined return message, the router directly obtains the payment information included in the return message.

In step S42, the router generates a payment push message in accordance with the obtained payment information. The generated payment push message includes information corresponding to the payment information, such as a payment link.

In step S43, the router sends the payment push message to at least one predetermined receiving terminal, similar to step S32 (FIG. 3).

Moreover, for payment on delivery, such as in ticket booking or on-line shopping, the return message can include additional information, such as logistics information, which can also be sent to the user in the payment push message.

The method 400 can not only save the user's time, but also enhance payment security.

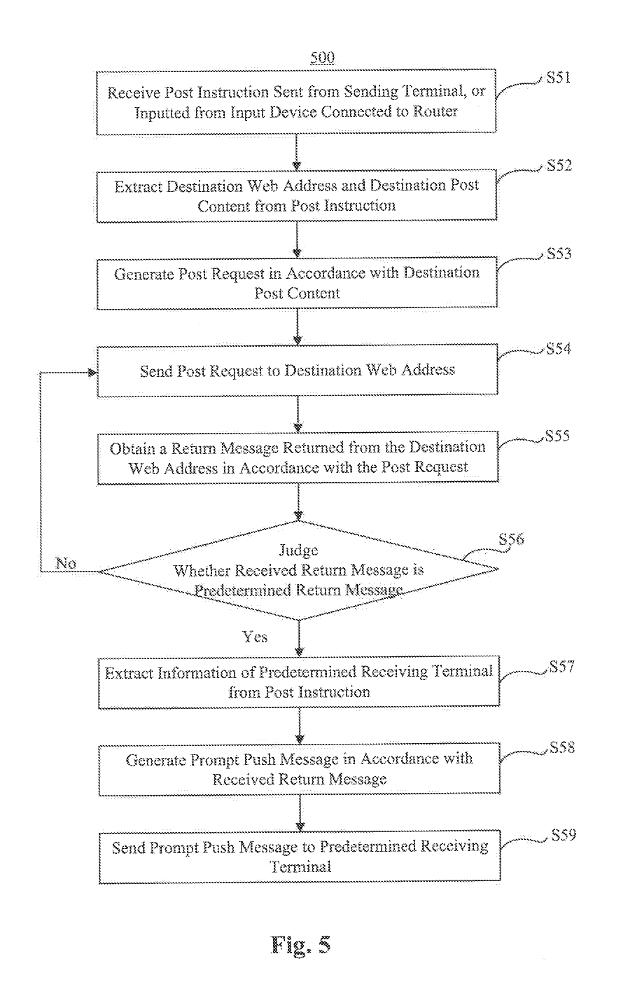

FIG. 5 is a flowchart of a method 500 for accessing a website, according to an exemplary embodiment. In the exemplary embodiment, the method 500 is used in a router. Referring to FIG. 5, the method 500 includes the following steps.

In step S51, the router receives a post instruction sent by a sending terminal or inputted by an input device connected to the router.

The sending terminal is connected to the router via a wired connection or a wireless connection. For example, the sending terminal can be a computer, a mobile phone, a tablet. etc.

The input device connected to the router can be, e.g., a touch panel, a keyboard, etc.

The post instruction includes at least a destination web address and destination post content. In one exemplary embodiment, the router can provide an interface, such as a table. The user can send the post instruction by the sending terminal or input the post instruction directly on the router.

In step S52, the router extracts the destination web address and the destination post content from the post instruction.

In step S53, the router generates a post request in accordance with the destination post content.

In step S54, the router sends the post request to the destination web address.

In step S55, the router receives a return message returned from the destination web address in accordance with the post request.

In step S56, the router judges whether the received return message is a predetermined message.

When the received return message is not the predetermined return message, the process returns to step S54 to continue to send the post request to the destination web address.

When the received return message is the predetermined return message, in step S57, the router extracts from the post instruction information of a predetermined receiving terminal for receiving a prompt push message.

In step S58, the router generates the prompt push message in accordance with the received return message.

In step S59, the router sends the prompt push message to the predetermined receiving terminal.

In exemplary embodiments, the post instruction includes the information of the predetermined receiving terminal. The information of the predetermined receiving terminal can be an IP address, an account or an ID, wherein the ID can be a mobile phone number. For example, the user can specify the information of the predetermined receiving terminal in advance.

The predetermined receiving terminal can be the same as the sending terminal, and can also be different from the sending terminal. In one exemplary embodiment, the user books tickets on a first computer, and sets the predetermined receiving terminal to be the first computer or a second computer, e.g., in the same local area network as the first computer. In one exemplary embodiment, when the user sends the post instruction by a computer, the user specifies a mobile phone as the receiving terminal, such that the user can receive the prompt push message by the mobile phone, if the booking is successful when the user is away from the computer. In one exemplary embodiment, an email address specified by the user is included in the post instruction, the user can obtain the prompt push message by checking email. In one exemplary embodiment, the prompt push message is sent in the form of a webpage pop-up window to the user once the booking is successful. In addition, when the user books tickets for multiple users, the user can specify mobile phones of the multiple users, respectively, as predetermined receiving terminals in the post instruction. After the ticket booking is successful, the prompt push message can be sent to the mobile phones of the multiple users.

In the illustrated embodiment, step S57 is performed after step S56, but the method 500 is not limited thereto.

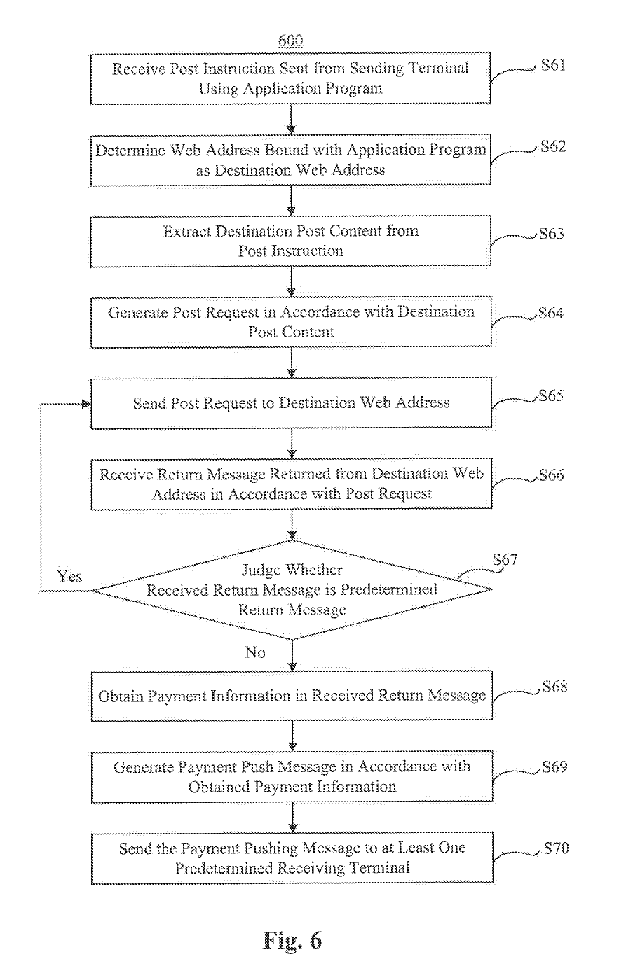

FIG. 6 is a flowchart of a method 600 for accessing a website, according to an exemplary embodiment. In the exemplary embodiment, the method 600 is used in a router. Referring to FIG. 6, the method 600 includes the following steps.

In step S61, the router receives a post instruction sent by a sending terminal using an application program. The post instruction includes at least destination post content.

In exemplary embodiments, one or more application programs may be installed on the router. Each of the application programs is bound with a predetermined web address. For example, for a train ticket booking website, an application for booking train tickets can be installed. Also for example, an application for shopping on the Taobao website can be installed. When the user needs a service, the user can input the post instruction by using the corresponding application.

In step S62, the router determines a web address bound with the application program as the destination web address.

Because each application program is bound with one predetermined web address, when receiving the post instruction by an application program, the web address bound with that application program can be determined as the destination web address.

In step S63, the router extracts the destination post content from the post instruction.

In step S64, the router generates a post request in accordance with the destination post content.

In step S65, the router sends the post request to the destination web address.

In step S66, the router receives a return message returned from the destination web address in accordance with the post request.

In step S67, the router judges whether the received return message is a predetermined return message.

When the received return message is not the predetermined return message, the process returns to step S65 to continue to send the post request to the destination web address, until the received return message is the predetermined return message.

When the received return message is the predetermined return message, in step S68, the router obtains payment information in the received return message.

In step S69, the router generates a payment push message in accordance with the obtained payment information.

In step S70, the router sends the payment push message to at least one predetermined receiving terminal.

In the illustrated embodiment, by installing different application programs on the router, the user can access an application program on the router, and input the post instruction including at least the post content using an input interface provided by the application program without inputting the destination web address, which facilitates sending the post request quickly, especially for users who usually access a destination web address by a portal website but are unfamiliar with detailed spelling of the web address.

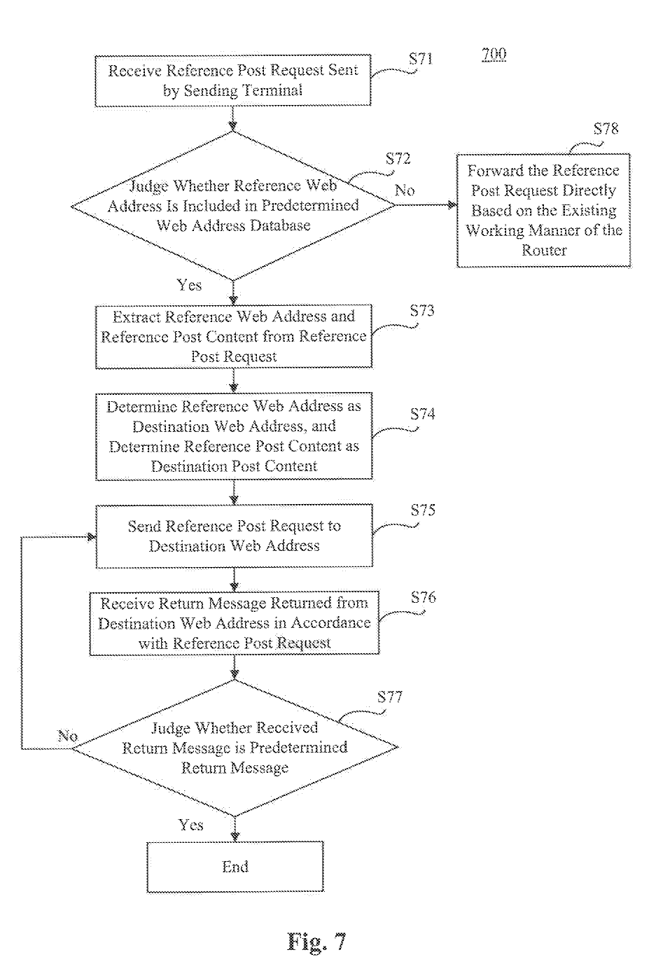

FIG. 7 is a flowchart of a method 700 for accessing a website, according to an exemplary embodiment. In the exemplary embodiment, the method 700 is used in a router. Referring to FIG. 7, the method 700 includes the following steps.

In step S71, the router receives a reference post request sent by a sending terminal.

In exemplary embodiments, the user can access a destination website directly by a browser on the sending terminal, and fill in post content for the destination website. The browser then generates a reference post request, and sends the reference post request to the router. The reference post request includes at least a reference web address and reference post content. Furthermore, the reference post request can include information of a predetermined receiving terminal.

In step S72, the router judges whether the reference web address is included in a predetermined web address database.

The web address database is provided in the router in advance. The web address database stores web addresses for shopping and ticket booking websites by default, or stores web addresses inputted by the user.

When the predetermined web address database includes the reference web address, in step S73, the reference web address and the reference post content are extracted from the reference post request. Alternatively, extracting the reference web address from the reference post request may also be implemented after step S71 and before step S72.

In step S74, the router determines the reference web address as the destination web address, and determines the reference post content as the destination post content.

When the predetermined web address database does not include the reference web address, in step S78, the reference post request is directly forwarded to the reference web address based on a current working mode of the router.

In step S75, the router sends the reference post request to the destination web address.

In step S76, the router receives a return message returned by the destination web address in accordance with the reference post request.

In step S77, the router judges whether the received return message is a predetermined return message.

When the received return message is not the predetermined message, the process returns to step S75 to continue to send the reference post request to the destination web address, until the received return message is the predetermined return message.

In the method 700, when the user needs to send multiple post requests to multiple destination web addresses, respectively, the user may directly perform operations on a browser of the terminal, without looking for the corresponding application programs on the router and inputting post instructions individually in the different applications programs. After the browser sends the multiple post requests to the router, the router can selectively and automatically send a post request multiple times until the return message is the predetermined message. The router can also selectively perform a forwarding operation, thereby decreasing the complexity of user operations.

In the above described embodiments, the user only needs to send the destination web address and the destination post content once to the router through the terminal, when obtaining the network resource, and remaining interactions among data are implemented between the router and the server corresponding to the destination web address. The above described methods need not present the return message of the post request to the user by the router and send the post request again by the user each time, which reduces the number of interactions between the router and the terminal, and further decreases the time for obtaining the network resource. In addition, the time interval of two adjacent post requests sent by the router is reduced, the number of sendings of the post requests through the router per unit time is increased, and a success rate of obtaining the network resource is improved.

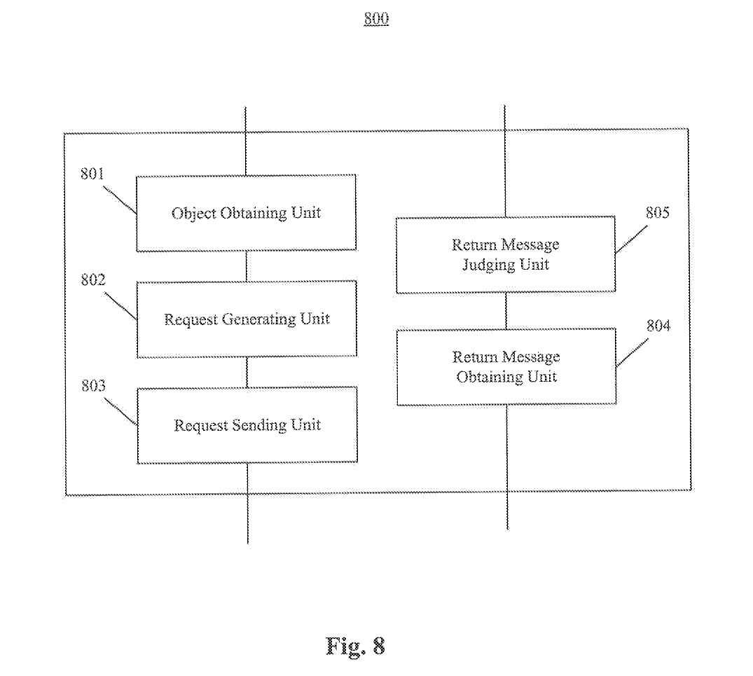

FIG. 8 is a block diagram of a device 800 for accessing a website, according to an exemplary embodiment. Referring to FIG. 8, the device 800 includes an object obtaining unit 801, a request generating unit 802, a request sending unit 803, a return message obtaining unit 804, and a return message judging unit 805.

The object obtaining unit 801 is configured to obtain a destination web address and destination post content.

In one exemplary embodiment, the object obtaining unit 801 includes a first instruction receiving unit and an object extracting unit. The first instruction receiving unit is configured to receive a post instruction sent by a sending terminal, or inputted by an input device connected to the router, the post instruction including at least the destination web address and the destination post content. The object extracting unit is configured to extract the destination web address and the destination post content from the post instruction.

In one exemplary embodiment, the object obtaining unit 801 includes a second instruction receiving unit, a destination web address determining unit, and a destination post content extracting unit. The second instruction receiving unit is configured to receive the post instruction sent by the sending terminal via an application program, the post instruction including at least the destination post content. The application program is bound with a predetermined web address. The destination web address determining unit is configured to determine the web address bounded by the application program as the destination web address; and the destination post content extracting unit is configured to extract the destination post content from the post instruction.

In one exemplary embodiment, the object obtaining unit 801 includes a request receiving unit, a web address judging unit, a reference object extracting unit, and a destination object determining unit. The request receiving unit is configured to receive the reference post request sent by the sending terminal, the reference post request including at least the reference web address and the reference post content. The web address judging unit is configured to judge whether a predetermined web address database includes the reference web address. The reference object extracting unit is configured to extract the reference web address and the reference post content from the reference post request if the predetermined web address database includes the reference web address. The destination object determining unit is configured to determine the reference web address as the destination web address, and to determine the reference post content as the destination post content.

The request generating unit 802 is configured to generate a post request in accordance with the destination post content.

The request sending unit 803 is configured to send the post request to the destination web address.

The return message obtaining unit 804 is configured to obtain a return message returned from the destination web address in accordance with the post request.

The return message judging unit 805 is configured to judge whether the return message is a predetermined return message.

If the return message is not the predetermined return message, the request sending unit 803 continues to send the post request to the destination web address, until the received return message is the predetermined return message.

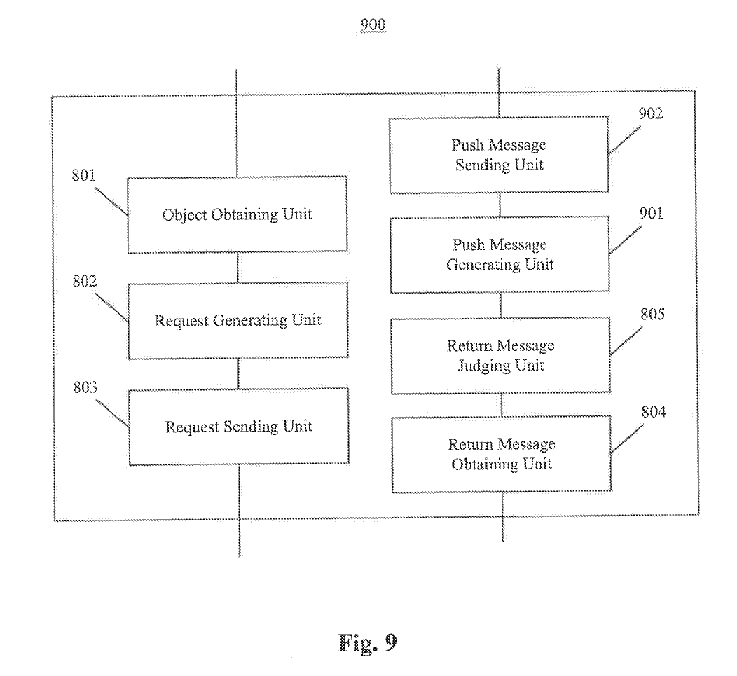

FIG. 9 is a block diagram of a device 900 for accessing a website, according to an exemplary embodiment. Referring to FIG. 9, the device 900 further includes a push message generating unit 901 and a push message sending unit 902, in addition to the components of the device 800 (FIG. 8).

The push message generating unit 901 is configured to generate a prompt push message in accordance with the return message if the return message as the predetermined return message.

The push message sending unit 902 is configured to send the prompt push message to at least one predetermined receiving terminal.

In exemplary embodiments, the push message is sent to the predetermined receiving terminal in a format including one of a text message, an email, a webpage message, an Internet push message, and a LAN notification message, or a combination thereof. The predetermined receiving terminal can be a mobile terminal, a computer, or any other network terminal.

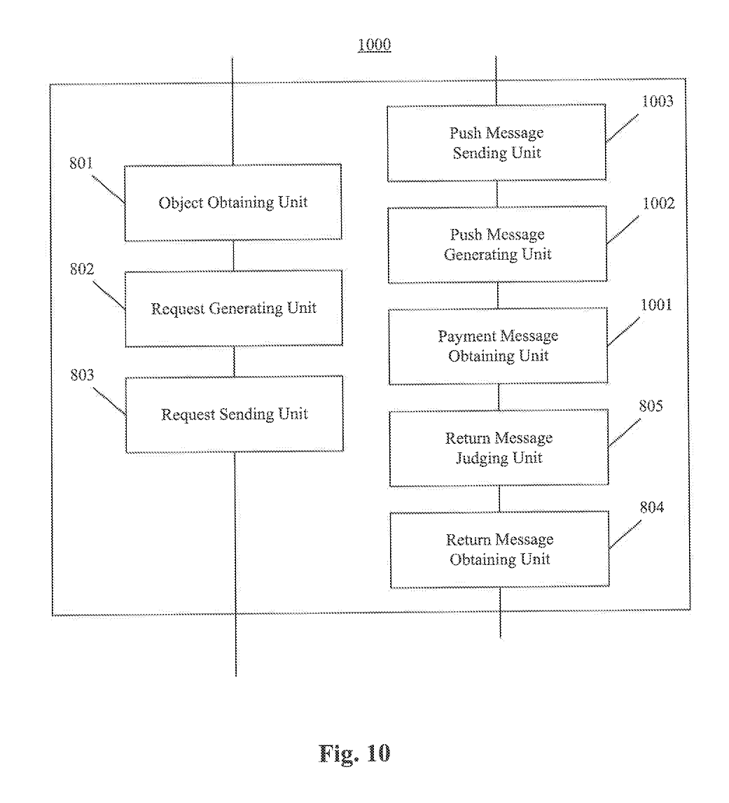

FIG. 10 is a block diagram of a device 1000 for accessing a website, according to an exemplary embodiment. Referring to FIG. 10, the device 1000 further includes a payment information obtaining unit 1001, a push message generating unit 1002, and a push message sending unit 1003, in addition to the components of the device 800 (FIG. 8).

The payment information obtaining unit 1001 is configured to obtain payment information in the received return message if the received return message is the predetermined return message.

The push message generating unit 1002 is configured to generate a payment push message in accordance with the obtained payment information.

The push message sending unit 1003 is configured to send the payment push message to at least one predetermined receiving terminal for receiving the payment push message.

Additionally, when a post instruction or a reference post request includes information of the predetermined receiving terminal, the device 1000 may further include a terminal information extracting unit. The terminal information extracting unit is configured to extract the information of the predetermined receiving terminal from the post instruction or the reference post request.

In one exemplary embodiment, the predetermined receiving terminal is the same as the terminal sending the post request. In one exemplary embodiment, the predetermined receiving terminal is different from the terminal sending the post request.

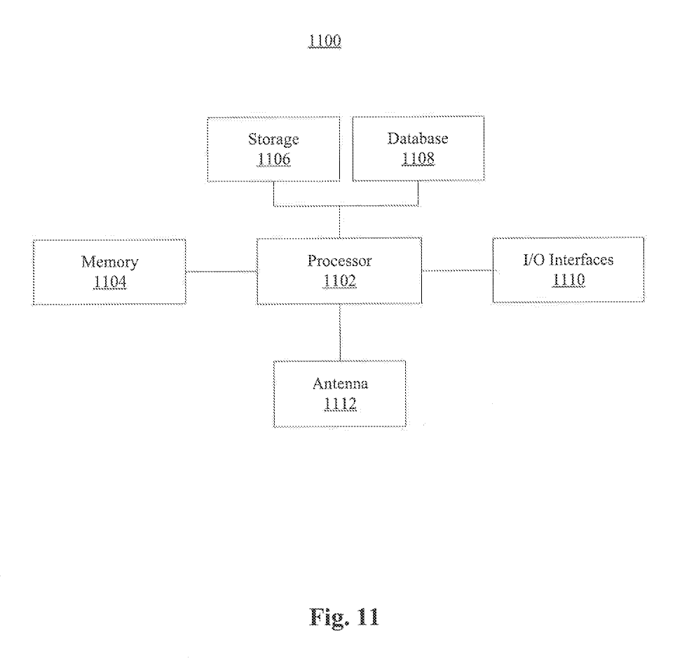

FIG. 11 is a block diagram of a router 1100, according to an exemplary embodiment. Referring to FIG. 11, the router 1100 may include one or more of the following components: a processor 1102 configured to execute program instructions to perform the above described methods, a memory 1104 configured to access and store information and program instructions, storage 1106 to store data and information, a database 1108 to store tables, lists, or other data structures, I/O interfaces 1110, an antenna 1112, etc.

In exemplary embodiments, there is also provided a non-transitory computer readable storage medium including instructions, such as included in the memory 1104, executable by the processor 1102 in the router 1100, for performing the above-described methods.

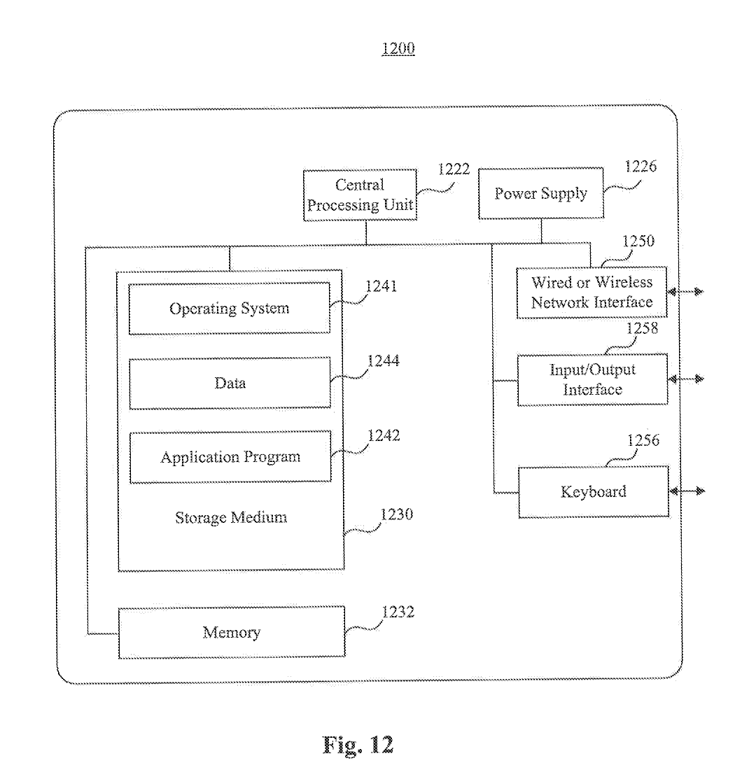

FIG. 12 is a block diagram of a server 1200, according to an exemplary embodiment. The server 1200 may include a central processing unit (CPU) 1222 including one or more processors, a memory 1232, and a storage medium 1230, such as one or more mass memory devices, for storing an operating system 1241, application programs 1242, and/or data 1244. Instructions stored in the storage medium 1230 may include one or more modules. Each of modules may include a series of instruction operations to the server 1200. Furthermore, the central processing unit 1222 may communicate with the storage medium 1230 to execute a series of instruction operations in the storage medium 1230 on the server 1200.

The server 1200 may also include a power supply 1226, a wired or wireless network interface 1250, an input/output interface 1258, and a keyboards 1256. The operating system 1241 can be Windows Server™, Mac OS X™, Unix™, Linux™, FreeBSD™, or the like.

One of ordinary skill in the art will understand that the above described units can each be implemented by hardware, or software, or a combination of hardware and software. One of ordinary skill in the art will also understand that multiple ones of the above described units may be combined as one unit, and each of the above described units may be further divided into a plurality of sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for use in a router, comprising:
obtaining a destination web address and destination post content;
generating a post request in accordance with the destination post content;
sending the post request to the destination web address;
receiving a return message returned from the destination web address in accordance with the post request;
judging whether the received return message is a predetermined return message; and
if the received return message is not the predetermined return message, continuing to send the post request to the destination web address until the received return message is the predetermined return message.

2. The method according to claim 1, further comprising:
if the received return message is the predetermined return message, generating a prompt push message in accordance with the received return message; and
sending the prompt push message to at least one predetermined receiving terminal.

3. The method according to claim 1, further comprising:
if the received return message is the predetermined return message, obtaining payment information in the received return message;
generating a payment push message in accordance with the payment information; and
sending the payment push message to at least one predetermined receiving terminal.

4. The method according to claim 2, wherein the prompt push message is sent to the at least one predetermined receiving terminal in a format of a text message, an email, a webpage message, an Internet push message, or a local area network (LAN) notification message, or a combination thereof.

5. The method according to claim 3, wherein the payment push message is sent to the at least one predetermined receiving terminal in a format of a text message, an email, a webpage message, an Internet push message, or a local area network (LAN) notification message, or a combination thereof.

6. The method according to claim 1, wherein the obtaining of the destination web address and the destination post content comprises:
receiving a post instruction sent from a sending terminal, or inputted from an input device connected to the router, the post instruction including at least the destination web address and the destination post content; and
extracting the destination web address and the destination post content from the post instruction.

7. The method according to claim 1, wherein the obtaining of the destination web address and the destination post content comprises:
receiving a post instruction sent from a sending terminal using an application program, the post instruction including at least the destination post content, the application program being bound with a predetermined web address;
determining the web address bound with the application program as the destination web address; and
extracting the destination post content from the post instruction.

8. The method according to claim 1, wherein the obtaining of the destination web address and the destination post content comprises:
receiving a reference post request sent from a sending terminal, the reference post request including at least a reference web address and reference post content;
judging whether the reference web address is included in a predetermined web address database;
if the reference web address is included in the predetermined web address database, extracting the reference web address and the reference post content from the reference post request; and
determining the extracted reference web address as the destination web address, and determining the extracted reference post content as the destination post content.

9. The method according to claim 6, wherein the post instruction includes information of a predetermined receiving terminal for receiving a prompt push message, the method further comprising:
extracting the information of the predetermined receiving terminal from the post instruction.

10. The method according to claim 7, wherein the post instruction includes information of a predetermined receiving terminal for receiving a prompt push message, the method further comprising:
extracting the information of the predetermined receiving terminal from the post instruction.

11. The method according to claim 8, wherein the reference post request includes information of a predetermined receiving terminal for receiving a prompt push message, the method further comprising:
extracting the information of the predetermined receiving terminal from the reference post request.

12. A router, comprising:
a processor;
a memory for storing instructions executable by the processor;
wherein the processor is configured to:
obtain a destination web address and destination post content;
generate a post request in accordance with the destination post content;
send the post request to the destination web address;
receive a return message returned from the destination web address in accordance with the post request;
judge whether the received return message is a predetermined return message; and
if the received return message is not the predetermined return message, continue to send the post request to the destination web address until the received return message is the predetermined return message.

13. The router according to claim 12, wherein the processor is further configured to:
if the received return message is the predetermined return message, generate a prompt push message in accordance with the received return message; and
send the prompt push message to at least one predetermined receiving terminal.

14. The router according to claim 12, wherein the processor is further configured to:
if the received return message is the predetermined return message, obtain payment information in the received return message;
generate a payment push message in accordance with the payment information; and
send the payment push message to at least one predetermined receiving terminal.

15. The router according to claim 13, wherein the prompt push message is sent to the at least one predetermined receiving terminal in a format of a text message, an email, a webpage message, an Internet push message, or a local area network (LAN) notification message, or a combination thereof.

16. The router according to claim 12, wherein the processor is further configured to:
receive a post instruction sent from a sending terminal, or inputted from an input device connected to the router, the post instruction including at least the destination web address and the destination post content; and
extract the destination web address and the destination post content from the post instruction.

17. The router according to claim 12, wherein the processor is further configured to:
receive a post instruction sent from a sending terminal using an application program, the post instruction including at least the destination post content, the application program being bound with a predetermined web address;
determine the web address bound with the application program as the destination web address; and
extract the destination post content from the post instruction.

18. The router according to claim 12, wherein the processor is further configured to:
receive a reference post request sent from a sending terminal, the reference post request including at least a reference web address and a reference post content;
judge whether the reference web address is included in a predetermined web address database;
if the reference web address is included in the predetermined web address database, extract the reference web address and the reference post content from the reference post request; and
determine the extracted reference web address as the destination web address, and determine the extracted reference post content as the destination post content.

19. The router according to claim 16, wherein the post instruction includes information of a predetermined receiving terminal for receiving a prompt push message, the processor being further configured to:
extract the information of the predetermined receiving terminal from the post instruction.

20. A non-transitory computer-readable storage medium storing therein instructions that, when executed by a processor of a router, cause the router to perform a method for accessing a website, the method comprising:
obtaining a destination web address and destination post content;
generating a post request in accordance with the destination post content;
sending the post request to the destination web address;
receiving a return message retuned from the destination web address in accordance with the post request;
judging whether the received return message is a predetermined return message; and
if the received return message is not the predetermined return message, continuing to send the post request to the destination web address until the received return message is the predetermined return message.
